(19) United States
(12) Patent Application Publication
(10) Pub. No.: US 2003/0117805 A1
(43) Pub. Date: Jun. 26, 2003

(54) High intensity directional lighting device

(75) Inventors: Barton A. Pasternak, Elkins Park, PA (US); Forrest A. Marshall, Dublin, GA (US)

Correspondence Address: DRINKER BIDDLE & REATH, ONE LOGAN SQUARE, 18TH AND CHERRY STREETS, PHILADELPHIA, PA, 19103-6996, US

(73) Assignee: Entire Interest

(21) Appl. No.: 10/081,092

(22) Filed: Feb. 21, 2002

Related U.S. Application Data
(60) Provisional application No. 60/289,486, filed on May 8, 2001.

(51) Int. Cl. F21V 21/10

(52) U.S. Cl. 362/429

(57) ABSTRACT

A device for providing high intensity directional lighting. The device may include a light bulb having a coating covering a portion of the bulb's surface area and an adjustable socket adapter. The adjustable socket adapter includes an upper portion for receiving a light bulb and a lower portion for engaging a socket. The upper portion and lower portion are hingedly and rotatably engaged.

This application claims the priority of earlier-filed provisional application serial No. 60/289,486, filed May 8, 2001.

### FIELD OF THE INVENTION

The subject invention relates generally to a device for providing high intensity directional lighting. The device may include a light bulb having a coating covering a portion of the bulb's surface area and a directionally adjustable socket adapter. The adjustable socket adapter includes members that are hingedly and rotatably attached so that light may be directed in a plurality of directions.

### BACKGROUND OF THE INVENTION

Various types of socket extenders are commonly provided to increase the reach of an existing light socket or to allow an existing light socket to accept more than one type of light bulb. To provide those features, prior art socket extenders comprise screw bases, of varying length, that are fixedly attached to non-rotatable outer housings having sockets therein.

Socket extenders, as described above, are limited to simply extending the length of the lamp in which the socket is placed. Furthermore, those socket extenders are not capable of directing light in a plurality of directions.

It is therefore desirable to provide a complete high intensity directional lighting device which enables a person to focus the light emitted by a standard or high-intensity light bulb in a plurality of directions as desired by simply and conveniently adjusting the lighting device.

### SUMMARY OF THE INVENTION

In accordance with the present invention, there is provided a device for providing high intensity directional lighting. The device includes an adjustable socket adapter having a rotatable upper portion for receiving a light bulb and a lower portion for engaging a lamp socket. The rotatable upper portion is rotatably and hingedly attached to the lower portion. The upper portion comprises an outer housing and an inner socket.

### BRIEF DESCRIPTION OF THE DRAWINGS

FIG. 1 is an exploded isometric view of a device for providing high intensity directional lighting having a light bulb and an adjustable socket adapter in accordance with an embodiment of the present invention.

FIG. 2 is a schematic cross-sectional view of an adjustable socket adapter and a partial isometric view of a light bulb in accordance with one embodiment of the present invention.

FIG. 3 is a plan view of a cross section taken along line A-A.

FIG. 4 is a schematic cross-sectional view of an adjustable socket adapter and a partial isometric view of a light bulb in accordance with one embodiment of the present invention.

FIG. 5 is an isometric view of a device for providing high intensity directional lighting wherein a light bulb is attached to the adjustable socket adapter and the adjustable socket adapter is in an upright position in accordance with an embodiment of the present invention.

FIG. 6 is an isometric view of a device for providing high intensity directional lighting wherein a light bulb is attached to the adjustable socket adapter and a hinge located between an upper and lower portion of the adjustable socket adapter has been angularly positioned approximately ninety (90) degrees in accordance with an embodiment of the present invention.

### DETAILED DESCRIPTION OF THE DRAWINGS

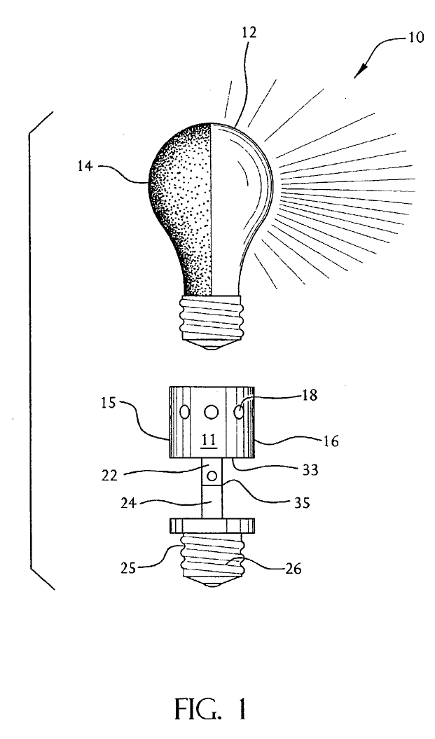

Referring now to figures wherein like reference numerals identify corresponding or similar elements throughout the several views, the present invention is illustrated in one or more configurations which are currently preferred. Referring to FIG. 1, an embodiment of a high intensity directional lighting device in accordance with the present invention, indicated generally by reference number 10, is shown. The lighting device 10 may include a standard or high intensity light bulb 12 having a coating 14 as well as a directionally adjustable socket adapter indicated by reference numeral 11. The coating 14 may be applied on the bulb's inner or outer surface or on both the inner and outer surfaces. The bulb's coating 14 allows light emitted from the bulb to be channeled in a particular direction while the adjustable socket adapter 11 allows that light to be focused in a plurality of directions as desired. While a bulb having a coating is shown, attaching a standard light bulb without a coating to the adjustable socket adapter 11 is well within the scope of the present invention.

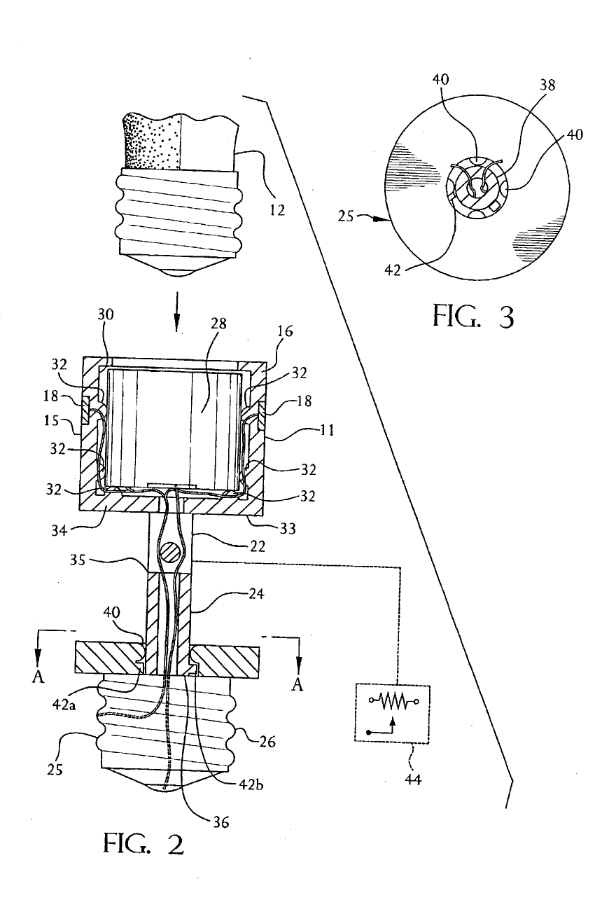

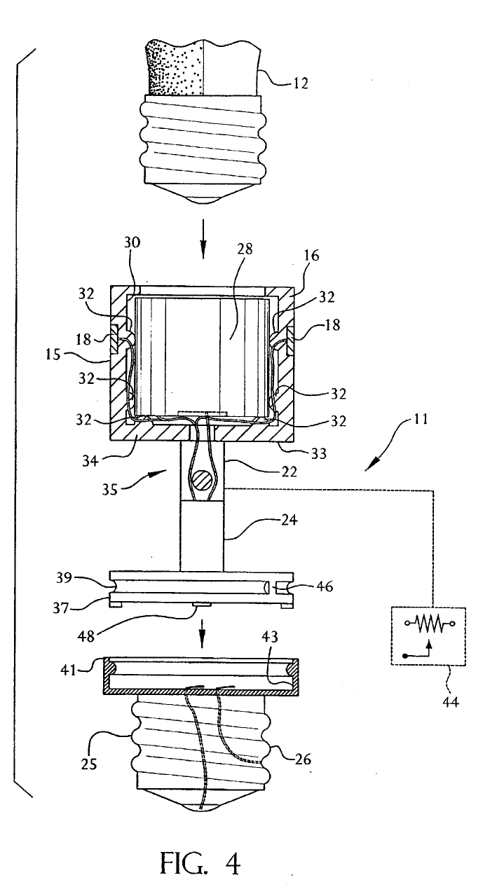

The adjustable socket adapter 11 of the lighting device 10 shown in FIG. 1 includes a rotatable upper portion 15 and a lower portion 25 that are hingedly and rotatably attached to each other. The upper portion 15 comprises an outer housing 16 as well as an inner socket 28 (see FIGS. 2, 4) for receiving the bulb. The lower portion 25 is adapted to engage a lamp socket or any socket and therefore, in the embodiment shown in FIG. 1, comprises a screw base 26. The particular dimensions of the screw base 26 may vary according to the socket being engaged. The rotatable upper portion 15 may be rotated and set in any position preferred within an at least 360 degree range of rotation while a hinge 35 may likewise be adjusted and set in a particular angular position so as to enable a user to direct light in a plurality of directions as desired.

In a preferred embodiment, the outer housing 16 may include a plurality of sensors 18 adapted to receive a remote signal for controlling the bulb's 12 intensity in a similar fashion to how a typical dimmer switch controls the amount of electrical power flowing to a particular device. In one embodiment, a resistor (see 44 at FIG. 2) or other suitable device may be located between the bulb and a source of electrical power. The ability to increase or decrease the brightness of a light bulb by varying the amount of electrical power delivered thereto is well known in the art and, for brevity's sake, will not be further discussed.

Referring now to FIG. 2, it can be seen that in one embodiment of the present invention, there is a socket 28 located within the outer housing 16 for receiving a light bulb 12. The inner surface of the outer housing 30 comprises a plurality of raised bulkheads 32. The bulkheads 32 act to keep the outer housing and the socket 28 in constant alignment so that by rotating the outer housing 270 degrees, for example, the socket 28 will also rotate 270 degrees. In a preferred embodiment, the bulkheads 32 are arranged in order to provide an interstitial space between the socket 28 and the outer housing for wires and the like.

As can be seen in FIG. 2, the hinge 35 includes a top leg 22 and a bottom leg 24. In this embodiment, the top leg 22 is cylindrical and fixedly attached to a bottom surface 33 of the outer housing 16. The bottom leg 24 is rotatably attached to the screw base 26 and is shown having two downward extending prongs but, as with the top leg 22, may be any shape that facilitates movement of the hinge 35. The bottom leg 24 is rotatably engaged by the screw base 26, as shown in FIG. 2, in such a manner that the rotation of the upper portion 15 is limited to 360 degrees with respect to the screw base 26. Limiting the rotation of the upper portion 15 with respect to the screw base 26 is preferable, in this embodiment, in order to prevent wires located within the adjustable socket adapter from twisting.

The bottom leg 24 of the hinge 35 may have a space throughout its vertical extent so that interior wires may run directly into the screw base 26. As shown in FIG. 2, the bottom leg 24 of the hinge 35 extends downward into the screw base 26. A section taken along line A-A, and shown in plan view in FIG. 3, illustrates the manner in which the upper portion 15 is rotatably engaged with the screw base 26.

As shown in FIGS. 2 and 3, the screw base 26 also has bulkheads 40 that are similar in structure to the bulkheads 32 on the inner surface of the outer housing 16. However, it is important to note that, while the bulkheads 40 at the screw base 26 are similar in structure to the bulkheads 32 at the outer housing 16, the bulkheads 40 at the screw base 26 exert a pressure onto the cylinder 38 which is appropriate for allowing the outer housing 16 to rotate in response to an applied force and remain locked in place once the force is removed. The bulkheads 32 and 40 are shown as semi-circles but may be any appropriate size or shape.

In a preferred embodiment, shown in FIG. 2, a stopping mechanism 42a, 42b is provided in order to prevent the outer housing from rotating more than 360 degrees. The outer housing 16, and thus the socket 28 and light bulb 12 can be positioned at any point within the 360 degrees range of rotation. A stopping mechanism is preferred in the embodiment shown in FIGS. 2 and 3 because of the manner in which the rotatable upper portion 15 is rotatably attached to the lower portion 25. As mentioned, in this embodiment, the upper portion 15 comprises an inner socket 28 and outer housing 16 both of which rotate with respect to the screw base 26 by being rotatably attached to the screw base 26. Such an arrangement, where the top leg 22 of the hinge 35 is fixedly attached to the outer housing 16 and the bottom leg 24 is rotatably attached to the screw base 26, may cause wires located therein to become twisted if the upper portion 15 is rotated more than 360 degrees. The stopping mechanism 42a, 42b prohibits the upper portion 15 from rotating more than 360 degrees. While a particular form of stopping mechanism is shown, any such mechanism capable of prohibiting the outer housing 16 from rotating more than 360 degrees may be used.

In this embodiment, the adjustable socket adapter 11 may alternatively be arranged such that its point of rotation is located where the top leg 22 meets the outer housing 16 as opposed to where the base member 37 meets the screw base 26. That is, the base member may be fixedly attached to the screw base while the top leg 22 is rotatably attached to the outer housing 16. Such an arrangement eliminates twisting of the wires located within the adjustable socket adapter and therefore allows the upper portion 15 to be rotated more than 360 degrees with respect to the lower portion 25. To rotatably attach the top leg 22 to the outer housing, those two items may be attached in a fashion similar to the manner in which the bottom leg 24 is attached to the screw base in FIG. 2.

In another embodiment of the present invention, shown in FIG. 4, the bottom leg 24 of the hinge 35 includes a circular base member 37 as well as an electrical contact 48 for transferring electrical power from the screw base 26 to the inner socket 28. The base member 37 includes a groove 39 along an outer surface of the base member's perimeter. The base member 37 is adapted to be received by the screw base 26 so that the groove 39 is slidably engaged by an abutment 41 running along an inner surface 43 of the screw base 26. In cross section, as shown in FIG. 4, it can be seen that the groove 39 and abutment 41 fit together much like a typical tongue and groove arrangement. While such an arrangement is presently preferred, any arrangement known in the art that facilitates slidable engagement of the two elements is within the scope of the present invention.

As with the previously described manner of rotatably attaching the upper 15 and lower 25 portions, a stop 46 may be provided to prevent interior wires from becoming twisted. The stop 46 prohibits the outer housing 16 from rotating more than 360 degrees with respect to the lower portion 25. The groove 39 and abutment 41 are adapted so that the upper portion may be rotated by applying an appropriate force and may remain in any position within the 360 degree range of rotation once the force is released. In this embodiment, however, the stop is purely for convenience sake as rotation of the upper portion will not result in twisting of the wires because the only point of rotation is at the lower portion which is electrically connected to the base member by way of electrical contacts.

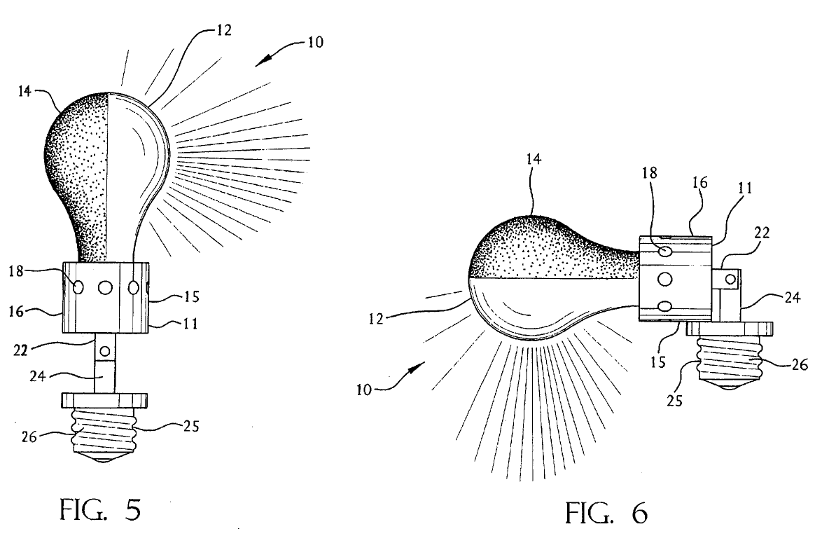

The adjustable socket adapter 11 may also be rotatably attached at both the upper portion 15 and the lower portion 25 in order to provide two axes of rotation and allow the upper portion to be rotated regardless of whether the socket adapter 11 is angularly positioned as shown in FIG. 6 or in a vertical position as shown in FIG. 5. In such an arrangement, the top leg 22 is rotatably attached to the outer housing 16 and the base member 37 is slidably engaged to the screw base so that the adapter 11 has two rotation points. A stopping mechanism may be provided as desired at either of the rotation points.

While specific embodiments have been described, each having different means for rotatably attaching the upper 15 and lower 25 portions so that the upper portion may be rotated with respect to the lower portion, other means for rotatably attaching two elements together are well known in the art and within the scope of the present invention. For example a ball joint, swivel joint or other suitable arrangement may be used in conjunction with any form of hinge to achieve the ability to direct light emanating from the light bulb in a plurality of directions. Furthermore, any number of rotation points may be located anywhere within the adjustable socket adapter 11 that allows the upper portion 15 to rotate with respect to the lower portion 25.

In addition to being able to rotate at least 360 degrees about at least one axis of rotation, the adjustable socket adapter 11 may also be angularly positioned by adjusting the hinge 35 located between the upper 15 and lower 25 portions. FIGS. 5 and 6 demonstrate the ability of the lighting device 10 to be angularly positioned as well as its ability to remain in a particular angular position once positioned, as desired.

In FIG. 5 the lighting device 10 is in an upright or vertical position with the outer housing 16 rotated so that the light emitted by the bulb is focused to the right. When the lighting device is arranged in an upright position, it may be rotated as desired at one or more rotations points depending on the embodiment and the number of rotation points provided. Obviously, when an adjustable socket adapter having two rotation points is in an upright position it does not matter which rotation point is utilized to position the device so that light is directed as desired.

In FIG. 6, the lighting device is shown angularly positioned 90 degrees to the left and the outer housing 16 is rotated so that the light emitted by the bulb is focused downward. While the lighting device is shown angularly positioned 90 degrees to the left in FIG. 6, it is important to note that the lighting device may also be angularly positioned 90 degrees to the right and also at any point in between.

Providing two points of rotation is especially useful when the hinge 35 has been used to angularly position the device in a particular position, as shown in FIG. 6. For instance, when the device is positioned as shown in FIG. 6, a user may want to rotate the device about a longitudinal axis defined by the light bulb 12, upper portion 15 and top leg 22, i.e. an axis perpendicular to the rotatable upper portion 15. To enable such movement, a rotation point may be provided where the top leg 22 meets the outer housing 16 by rotatably attaching the top leg 22 to the outer housing 16 as previously described. A user may also want to rotate the device about an axis defined by the bottom leg 24, i.e. an axis perpendicular to the lower portion 25. To enable such movement a rotation point may be provided where the bottom leg 24 meets the screw base 26 by rotatably attaching the bottom leg 24 to the screw base 26, preferably, but not necessarily, as shown in FIG. 4.

The present invention's ability to focus light in a plurality of alternative directions as desired provides a number of useful functions. For instance, people suffering from visual impairment may use the invention to conveniently focus light emitted by a light bulb directly on a particular object or location to help them read, operate mechanical/electrical devices, take medicine, cook, or perform hand-tasks such as knitting, sewing, drawing, etc. The list is not meant to be exhaustive but merely a sample of the beneficial uses of the present invention. In such situations, the present invention may prove especially useful for people suffering from macular degeneration where bright light incident upon an object makes that object easier to see.

For people with healthy eyes and no apparent visual impairment, the present invention may be used in much the same way to reduce the strain on the eye when performing anyone of the tasks mentioned, as examples, above. Obviously, the present invention is especially useful for conveniently increasing the amount of light incident on a particular object. Such an increase in light may be desirable simply out of preference or out of necessity when performing tasks in otherwise dimly lit rooms, for example. In fact, normal age-linked changes in retinal sensitivity for visual recognition under dim illumination has been reported as requiring approximately 700% more light intensity at age 55 than at age 21.

As can be seen from the description above, the directionally adjustable socket adapter of the present invention is portable. If a user is unhappy with the direction of light being emitted by a particular lamp or simply would like to focus that light towards their lap, to read, for example, they may simply remove the bulb from the lamp, insert the adjustable socket adapter, and replace the bulb. Once the adjustable socket adapter and bulb are in place, the light may be focused in any direction desired by simply positioning the adjustable socket adapter in a desired position.

The present invention may be embodied in other specific forms without departing from the spirit or essential attributes thereof.

What is claimed is:

1. An adjustable device for providing high intensity directional lighting, the device comprising:
a directionally adjustable socket adapter having;
a rotatable upper portion for receiving a light bulb; and
a lower portion adapted to engage a socket wherein said rotatable upper portion is hingedly and rotatably attached to said lower portion so that the directionally adjustable socket adapter may be positioned in a plurality of alternative directional arrangements.

2. A device as in claim 1, wherein the rotatable upper portion comprises an outer housing and an inner socket.

3. A device as in claim 2, wherein the outer housing further comprises a plurality of sensors adapted to receive a remote signal for controlling the brightness of a light bulb in response to the signal.

4. A device as in claim 1, wherein the rotatable upper portion is adapted to rotate at least 360 degrees about an axis perpendicular to the rotatable upper portion.

5. A device as in claim 4, wherein the directionally adjustable socket adapter is adapted so that the socket adapter can be further adjusted by angularly positioning the rotatable upper portion in relation to the lower portion as desired and by rotating the angularly positioned rotatable upper portion to a desired point within an at least 360 degree range of rotation about an axis perpendicular to the lower portion.

6. A device as in claim 1, further comprising a light bulb.

7. A device as in claim 6, wherein the light bulb comprises a coating adapted to focus light emitted by the bulb in a particular direction.

8. An adjustable device for providing high intensity directional lighting, the device comprising:
a light bulb having a coating adapted to focus light emitted by the bulb in a particular direction; and
a directionally adjustable socket adapter having;
a rotatable upper portion for receiving the light bulb; and
a lower portion adapted to engage a socket wherein said rotatable upper portion is hingedly and rotatably attached to said lower portion so that the light emitted by the light bulb may be focused on a particular location as desired.

9. A device as in claim 8, wherein the rotatable upper portion comprises an outer housing and an inner socket.

10. A device as in claim 9, wherein the outer housing further comprises a plurality of sensors adapted to receive a remote signal for controlling the brightness of a light bulb in response to the signal.

11. A device as in claim 8, wherein the rotatable upper portion is adapted to rotate at least 360 degrees about an axis perpendicular to the rotatable upper portion.

12. A device as in claim 11, wherein the directionally adjustable socket adapter is adapted so that the socket adapter can be further adjusted by angularly positioning the rotatable upper portion in relation to the lower portion as desired and by rotating the angularly positioned rotatable upper portion to a desired point within an at least 360 degree range of rotation about an axis perpendicular to the lower portion.

13. An adjustable device for providing high intensity directional lighting, the device comprising:
a directionally adjustable socket adapter having;
a rotatable upper portion for receiving a light bulb;
a lower portion hingedly and rotatably attached to said upper rotatable portion; and
being adapted so that the directionally adjustable socket adapter may be rotated at least 360 degrees about at least one axis of rotation and angularly positioned in a plurality of angular positions for positioning the adjustable socket in a plurality of alternative directional arrangements.

14. An adjustable device as in claim 13, wherein the directionally adjustable socket adapter is adapted to be rotated at least 360 degrees about two axes of rotation.
